(19) United States
(12) Patent Application Publication
(10) Pub. No.: US 2010/0250764 A1
(43) Pub. Date: Sep. 30, 2010

(54) Method and Apparatus for Signaling Layer Information of Scalable Media Data

(75) Inventors: Jani Petteri Vare, Kaarina (FI); Jyrki Tapio Alamaunu, Turku (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/415,576

(22) Filed: Mar. 31, 2009

(51) Int. Cl. G06F 15/16

(52) U.S. Cl. 709/231

(57) ABSTRACT

In accordance with an example embodiment of the present invention, a method and apparatus are described for mapping one or more layers of a scalable media stream to at least one physical layer pipe of a transmission. Information related to the mapping is transmitted. Also, the one or more layers are transmitted in the at least one physical layer pipe. Further, a method and apparatus are shown for receiving data in a transmission in at least one physical layer pipe. Information is received in related to a mapping of one or more layers of a scalable media stream to the at least one physical layer pipe. Based on the received information related to the mapping, the one or more layers of the scalable media stream in the received data are identified.

### TECHNICAL FIELD

The present application relates generally to signaling layer information of scalable media data for example in a scalable media stream.

### BACKGROUND

In a transmission of a media stream, the media stream may comprise one or more layers. For example, a video stream may comprise layers of different video quality. Scalable video coding (SVC) implements a layered coding scheme for encoding video sequences. Also, audio and other media data may be coded in a layered coding scheme. In an example embodiment, a scalable media stream is structured in a way that allows the extraction of one or more sub-streams, each sub-stream being characterized by different properties of the media data transmitted in the layers.

Properties of a scalable video stream may be a quality of the video stream, a temporal resolution, a spatial resolution, and the like. A scalable video stream may comprise a base layer and one or more enhancement layers. Generally, the base layer carries a low quality video stream corresponding to a set of properties, for example for rendering a video content comprised in a media stream on an apparatus with a small video screen and a low processing power, such as a small handheld device like a mobile phone. One or more enhancement layers may carry information which may be used on an apparatus with a bigger display and more processing power. An enhancement layer improves one or more properties compared to the base layer. For example, an enhancement layer may provide an increased spatial resolution as compared to the base layer. Thus, a larger display of an apparatus may provide an enhanced video quality to the user by showing more details of a scene by supplying a higher spatial resolution. Another enhancement layer may provide an increased temporal resolution. Thus, more frames per second may be displayed allowing an apparatus to render motion more smoothly. Yet another enhancement layer may provide in increased quality by providing a higher color resolution and/or color depth. Thus, color contrast and rendition of color tones may be improved. A further enhancement layer may provide an increased visual quality by using a more robust coding scheme and/or different coding quality parameters. Thus, less coding artifacts are visible on the display of the apparatus, for example when the apparatus is used under conditions when the quality of the received signal that carries the transmission is low or varies significantly.

While a base layer that carries the low quality video stream requires a low bit or symbol rate, every enhancement layer may increase the bit or symbol rate and therefore increase the processing requirements of the receiving apparatus. Enhancement layers may be decoded independently, or they may be decoded in combination with the base layer and/or other enhancement layers.

The media stream may also comprise an audio stream comprising one or more layers. A base layer of an audio stream may comprise audio of a low quality, for example a low bandwidth, such as 4 kHz mono audio as used in some telephony systems, and a basic coding quality. Enhancement layers of the audio stream may comprise additional audio information providing a wider bandwidth, such as 16 kHz stereo audio or multichannel audio. Enhancement layers of the audio stream may also provide a more robust coding to provide an enhanced audio quality in situations when the quality of the received signal that carries the transmission is low or varies significantly.

### SUMMARY

Various aspects of examples of the invention are set out in the claims.

According to a first aspect of the present invention, a method is disclosed, comprising mapping one or more layers of a scalable media stream to at least one physical layer pipe of a transmission. Information related to the mapping is transmitted. Further, the one or more layers are transmitted in the at least one physical layer pipe.

According to a second aspect of the present invention, a method is described comprising receiving data in at least one physical layer pipe. Information is received related to a mapping of one or more layers of a scalable media stream to the at least one physical layer pipe. Based on the received information related to the mapping, the one or more layers of the scalable media stream in the received data are identified.

According to a third aspect of the present invention, an apparatus is shown comprising a controller configured to map one or more layers of a scalable media stream to at least one physical layer pipe of a transmission. The apparatus further comprises a transmitter configured to transmit information related to the mapping. The transmitter is further configured to transmit the one or more layers in the at least one physical layer pipe.

According to a fourth aspect of the present invention, an apparatus is disclosed comprising a receiver configured to receive data in at least one physical layer pipe. The receiver is further configured to receive information related to a mapping of one or more layers of a scalable media stream to the at least one physical layer pipe. The apparatus also comprises a controller configured to identify the one or more layers of the scalable media stream in the received data based on the received information related to the mapping.

According to a fifth aspect of the present invention, a computer program, a computer program product and a computer-readable medium bearing computer program code embodied therein for use with a computer are disclosed, the computer program comprising code for mapping one or more layers of a scalable media stream to at least one physical layer pipe of a transmission, code for transmitting information related to the mapping, and code for transmitting the one or more layers in the at least one physical layer pipe.

According to a sixth aspect of the present invention, a data structure for a component identifier descriptor is described, the data structure comprising a mapping of one or more layers of a scalable media stream to at least one physical layer pipe of a transmission.

### BRIEF DESCRIPTION OF THE DRAWINGS

For a more complete understanding of example embodiments of the present invention, reference is now made to the following descriptions taken in connection with the accompanying drawings in which:

FIG. 1 shows a transmission system according to an embodiment of the invention;

FIG. 2 shows symbols of a data frame of a DVB transmission;

FIG. 3 a flowchart of a method for transmitting packets of a scalable media stream comprising signaling information according to an example embodiment of the invention;

FIG. 4 shows a flowchart of a method for transmitting signaling information of a scalable media stream according to an example embodiment of the invention;

FIG. 5 shows a flowchart of a method for transmitting signaling information of a scalable media stream according to an example embodiment of the invention;

FIG. 6 shows a flowchart of a method for receiving packets of a scalable media stream comprising signaling information according to an example embodiment of the invention;

FIG. 7 shows an example embodiment of a head-end including signaling information in a transmission;

FIG. 8 shows functional blocks of an apparatus configured to receive a scalable media stream and to process signaling information according to an example embodiment; and

FIG. 9 shows building blocks of an apparatus configured to receive packets of a scalable media stream according to an example embodiment.

### DETAILED DESCRIPTION OF THE DRAWINGS

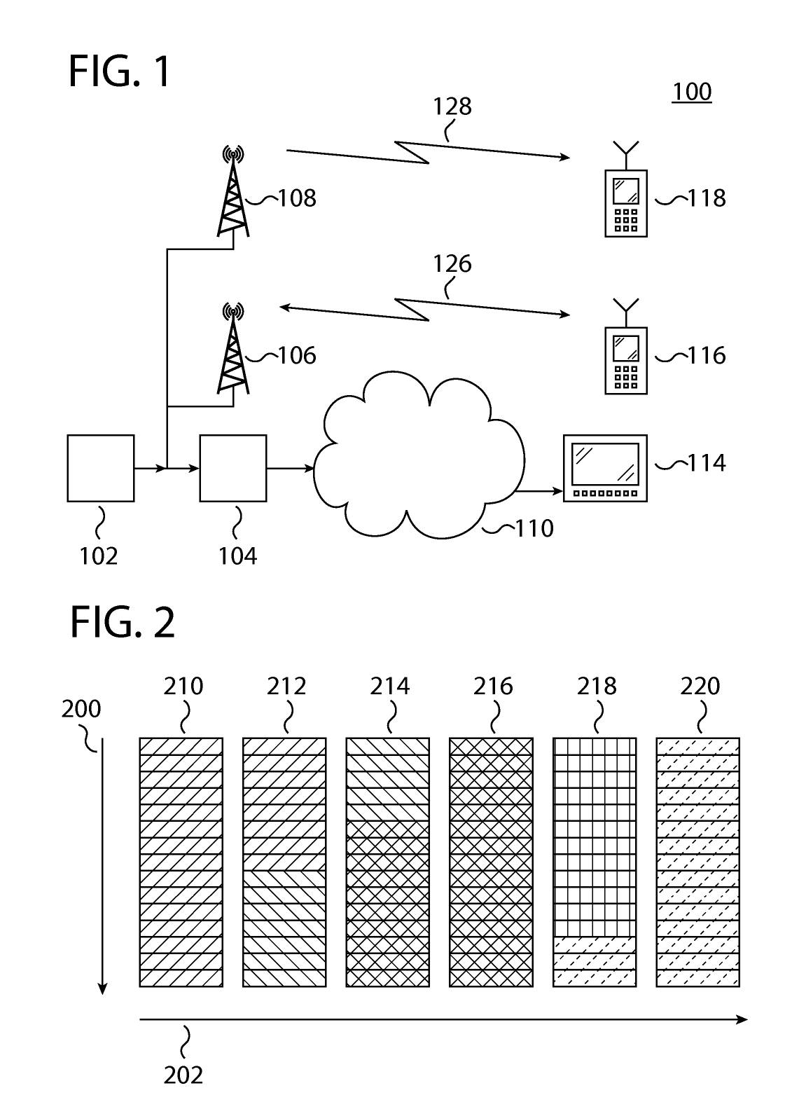

An example embodiment of the present invention and its potential advantages are understood by referring to FIGS. 1 through 9 of the drawings.

In a unicast, broadcast or multicast transmission, scalable video coding (SVC) may be used to address a variety of receivers with different capabilities efficiently. A receiver may subscribe to the layers of the media stream in accordance with a configuration at the apparatus, for example depending on the capabilities of the apparatus. The capabilities may be a display resolution, a color bit depth, a maximum bit rate capability of a video processor, a total data processing capability reserved for media streaming, audio and video codecs installed, and/or the like. The configuration for receiving certain layers may also be considered based on a user requirement within the limits of the processing and rendering capabilities of the apparatus. For example, a user may indicate a low, medium or high video quality and/or a low, medium or high audio quality. Especially in battery powered apparatuses there may be a trade-off between streaming quality and battery drain or battery life. Therefore, a user may configure the device to use a low video quality and a medium audio quality. In this way, an operation point is selected that allows battery usage of the apparatus for a longer time as compared to a high video and a high audio quality. Thus, the device may receive a subset of the layers of the transmission required to provide the media stream to the user at the selected operation point. The device may or may not receive other layers that are not required.

In a transmission, SVC may be used to address the receiver capabilities by sending out the base layer and one or more enhancement layers depending on receiver capabilities and/or requirements of the targeted receivers. It may further be used to adapt the streaming rate to a varying channel capacity.

FIG. 1 shows a transmission system 100 according to an embodiment of the invention. A service provider 102 provides a media stream. The media stream may be transmitted over the internet 110 by an internet provider 104 using a cable connection to apparatus 114, for example a media player, a home media system, a computer, or the like. The media stream may also be transmitted by a transmitting station 106 to an apparatus 116 using a unicast transmission 126. The unicast transmission 126 may be bidirectional. The unicast transmission may be a cellular transmission such as a global system for mobile communications (GSM) transmission, a digital advanced mobile phone system (D-AMPS) transmission, code division multiple access (CDMA) transmission, wideband-CDMA (W-CDMA) transmission, a personal handy-phone system (PHS) transmission, a 3^{rd} generation systems like Universal Mobile Telecommunications System (UMTS) transmission, a cordless transmission like a digital enhanced cordless telecommunication (DECT) transmission, and/or the like.

Further, the media stream from service provider 102 may be transmitted by a transmitting station 108 to an apparatus 118 using a broadcast or multicast transmission 128. The broadcast or multicast transmission may be a digital video broadcast (DVB) transmission according to the DVB-H (handheld), DVB-T (terrestrial), DVB-T2 (terrestrial, second generation), DVB-NGH (next generation handheld) standard, or according to any other digital broadcasting standard such as DMB (digital media broadcast), ISDB-T (Integrated Services Digital Broadcasting-Terrestrial), MediaFLO (forward link only), or the like.

Scalable video coding (SVC) may be used for streaming in a transmission. SVC provides enhancement layers carrying information to improve the quality of a media stream in addition to a base layer that provides a base quality, for example a low resolution video image and/or a low bandwidth mono audio stream.

In a DVB system, a physical layer pipe (PLP) may be used to transport one or more services. A service may be a media stream, a component of a media stream, such as a video or audio component of the media stream, a layer of a component of a layered coded media stream, and/or the like. A PLP may have a unique identification (ID), for example an 8-bit number, which uniquely identifies the PLP within the DVB system.

A PLP may be carried in a data frame, for example in a physical layer frame. In an example embodiment, a PLP may also be carried in a slice of the data frame, so that several PLPs may be carried in the same data frame.

FIG. 2 shows symbols of a data frame, for example of a physical layer frame, of a DVB transmission, such as a DVB-T2 or a DVB-NGH transmission. Carriers of an orthogonal frequency division multiplex (OFDM) system are shown along axis 200. Axis 202 represents time. OFDM symbols 210, 212, 214, 216, 218 and 220 may be used to carry PLPs. For example, OFDM symbol 210 and a first part of OFDM symbol 212 transport a first PLP, marked by a first diagonal hatch. A second part of OFDM symbol 212 and a first part of OFDM symbol 214 transport a second PLP, marked by a second diagonal hatch. A second part of OFDM symbol 214 and OFDM symbol 216 transport a third PLP, marked by a cross hatch. Likewise, OFDM symbols 218 and 220 transport a forth and fifth PLP.

Layer 1 signalling may be used to inform the receiver of how the PLPs are mapped to the OFDM symbols. In an example embodiment, layer 1 signalling may comprise information about the mapping of the PLPs to DVB data packets.

In an example embodiment, PLPs of FIG. 2 may be used to transmit one or more layers of a scalable media stream. For example, the first PLP carried in OFDM symbols 210 and 212 may transmit a video base layer. The second and third PLP may carry a first and second video enhancement layer. The fourth and fifth PLP may transport a base audio layer and an enhancement audio layer, respectively.

Information related to the mapping of the one or more layers of the scalable media stream to the PLPs may be transmitted in a descriptor, in a table or in any similar signaling structure, for example in a component identifier descriptor. The component identifier descriptor may be sent in the same transmission as the scalable media stream. The component identifier descriptor may carry other information in addition to the mapping information. In an example embodiment, the component identifier descriptor comprises a universal resource identifier (URI), for example an internet or web address of a service. Table 1 shows an example component identifier descriptor:

TABLE 1
Component identifier descriptor

| | | |
|---|---|---|
| Syntax | Number of bits | Format |

component_identifier_descriptor ( ) {

| | | |
|---|---|---|
| descriptor_tag | 8 | uimsbf |
| descriptor_length | 8 | uimsbf |
| descriptor_tag_extension | 8 | uimsbf |
| uri_association_loop ( ) { | | |
| uri_length (M) | 16 | uimsbf |
| for (i=0; i<M; I++) { | | |

| | | |
|---|---|---|
| uri_char | 8 | bslbf |

| | | |
|---|---|---|
| } | | |
| PLP_loop_length (N) | 8 | uimsbf |
| for (i=0; i<N; I++) { | | |

| | | |
|---|---|---|
| component_type | 8 | uimsbf |
| PLP_id | 8 | uimsbf |

}
}

}

The component identifier descriptor may carry numerical values, for example in an “unsigned integer most significant bit first” (uimsbf) format. The component identifier descriptor may also carry characters or strings, for example in a “bit string left bit first” (bslbf) format.

The mapping of the one or more layers of the scalable media stream to the PLPs is defined within the component identifier descriptor of Table 1 in the PLP loop after the definition of the number of PLPs “N” (as PLP_loop_length). In the loop, for each component type, for example “component_type”, a PLP is assigned, identified by the unique ID of the PLP “PLP_id”.

As the scalable media stream may represent a service or be part of a service, the “uri association loop” may provide a URI of the service.

Table 2 shows an example embodiment of a mapping of component types to the 8 bit integer value used as “component_type” in the component identifier descriptor of Table 1.

TABLE 2
Component types

| Component type | value |
|---|---|
| Base layer video stream | 0x00 |
| Enhancement layer video stream | 0x01 |
| Audio stream | 0x02 |
| Data stream | 0x03 |
| user defined | 0x04-0xFF |

In an example embodiment, more than one enhancement layer of the video stream is used and an enhancement layer of the audio stream is used. Thus, the “user defined” values can be assigned to the additional enhancement values. Table 3 shows an example mapping with user defined values 0x04 to 0x06 and values 0x07-0xFF still available for further user definitions:

TABLE 3
Component types, user defined

| Component type | value |
|---|---|
| Base layer video stream | 0x00 |
| Enhancement layer video stream | 0x01 |
| (Base layer) audio stream | 0x02 |
| Data stream | 0x03 |
| Enhancement layer 2, video stream | 0x04 |
| Enhancement layer 3, video stream | 0x05 |
| Enhancement layer, audio stream | 0x06 |
| user defined | 0x07-0xFF |

In the example embodiment of Table 3, a base layer of a video stream is indicated by a hexadecimal value 0x00, an enhancement layer of the video stream by value 0x01, and a second and third enhancement layer of the video stream by values 0x03 and 0x04, respectively. A base layer of an audio stream is indicated by a hexadecimal value 0x02, and an enhancement layer of the audio stream by value 0x06. Further, a data stream may be indicated by hexadecimal value 0x03.

Any other format of a component identifier descriptor for mapping PLPs to layers of a scalable media stream may be used. Further, any other format for indicating layers of a scalable media stream may be used.

Information about the layers of a scalable media stream may be transmitted in a service description file, for example a file according to the Session Description Protocol (SDP). The SDP is defined by the Internet Engineering Task Force (IETF) as RFC 4566 (“Request For Comments”, downloadable on http://www.ietf.org) in July 2006 and is included by reference. SDP is used to describe information on a session, for example media details, transport addresses, and other session description metadata. However, any other format to describe information of a session may be used.

A session description file may include information on layers. Information on layers may be marked with an information tag “i=” plus the layer information. For example, information on a layer may be tagged “i=baselayer” to indicate that information on a base layer is described. In another example, information on a layer may be tagged “i=enhancementlayer” to indicate that information on an enhancement layer is described.

The following extract of an SDP file shows an example of information on layers in an SDP file, where layer information is marked with an i-tag (Example 1):

### Example 1

m=video 10020 RTP/AVP 96
i=baselayer
c=IN IP4 232.199.2.0
b=AS:384
a=control:streamid=1
a=StreamId:integer;1
a=rtpmap:96 H264/90000
a=fmtp:96 profile-level-id=42E00C;sprop-parameter-
sets=Z0LgDJZUCg/I,aM48gA==;packetization-mode=1
m=video 10020 RTP/AVP 96
i=enhancementlayer
c=IN IP4 232.199.2.1
b=AS:384
a=control:streamid=1
a=StreamId:integer;1
a=rtpmap:96 H264/90000
a=fmtp:96 profile-level-id=42E00C;sprop-parameter-
sets=Z0LgDJZUCg/I,aM48gA==;packetization-mode=1

In another example, information on a layer may be tagged with an attribute “a=” tag as “a=videolayer:base” to indicate that information on a video base layer is described. In a further example, information on a layer may be tagged “a=videolayer:enhancement” to indicate that information on an enhancement layer is described. Similarly, an audio base layer may be tagged as “a=audiolayer:base” and an audio enhancement layer as “a=audiolayer:enhancement”.

The following extract of an SDP file shows an example of information on layers in an SDP file, where layer information is marked with an a-tag (Example 2):

### Example 2

m=video 10020 RTP/AVP 96
c=IN IP4 232.199.2.0
b=AS:384
a=videolayer:base
a=control:streamid=1
a=StreamId:integer;1
a=rtpmap:96 H264/90000
a=fmtp:96 profile-level-id=42E00C;sprop-parameter-
sets=Z0LgDJZUCg/I,aM48gA==;packetization-mode=1
m=video 10020 RTP/AVP 96
c=IN IP4 232.199.2.1
b=AS:384
a=videolayer:enhancement
a=control:streamid=1
a=StreamId:integer;1
a=rtpmap:96 H264/90000
a=fmtp:96 profile-level-id=42E00C;sprop-parameter-
sets=Z0LgDJZUCg/I,aM48gA==;packetization-mode=1

In an example embodiment, several enhancement layers may be coded in a session description file as shown in examples 1 and 2.

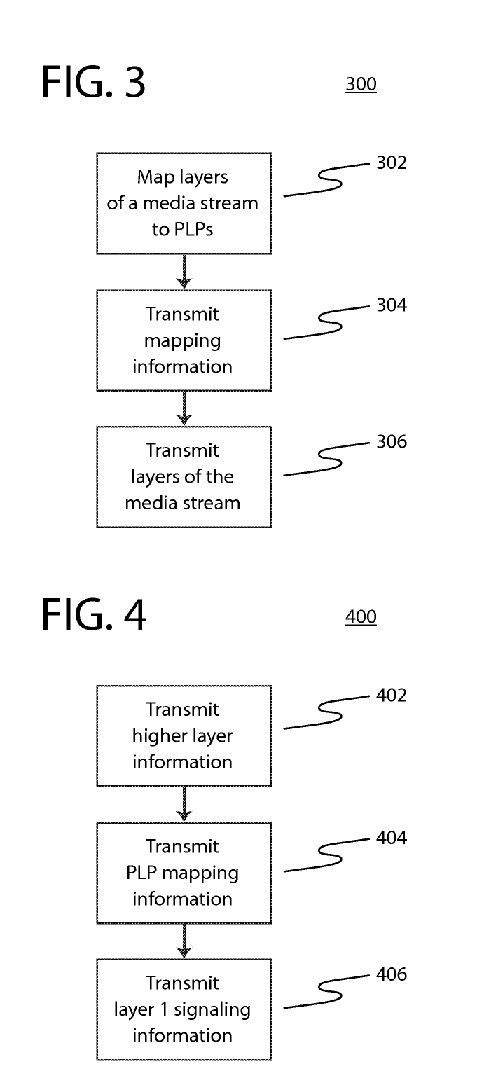

FIG. 3 shows a flowchart of a method 300 for transmitting packets of a scalable media stream comprising signaling information according to an example embodiment of the invention, for example by internet provider 104 and/or transmitters 106, 108 of FIG. 1. At block 302, one or more layers of a scalable media stream are mapped to at least one physical layer pipe of a transmission, for example of a broadcast transmission, such as a broadcast transmission of a DVB-T2 system or any other broadcast transmission system. At block 304, the mapping information is transmitted, for example by transmitting a component identifier as described in relation to Table 1 in the transmission. At block 306, the one or more layers of the scalable media stream are transmitted in the one or more physical layer pipes. By transmitting the mapping information, a receiver may be enabled to identify the layers of the scalable media stream in the physical layer pipes.

FIG. 4 shows a flowchart of a method 400 for transmitting signaling information of a scalable media stream according to an example embodiment of the invention, for example by internet provider 104 and/or transmitters 106, 108 of FIG. 1. The flowchart of FIG. 4 reflects the layers according to the open system interconnectin reference model (OSI model), also known as the OSI seven layer model. At block 402, higher layer information is transmitted, for example session description information describing the scalable media layers in a session description file. At block 404, PLP mapping information is transmitted, for example by transmitting the component identifier as described in relation to table 1 as layer 2 signaling information as in block 304 of FIG. 3. At block 406, layer 1 signaling information is transmitted, such as information associating the PLPs with the physical layer frames.

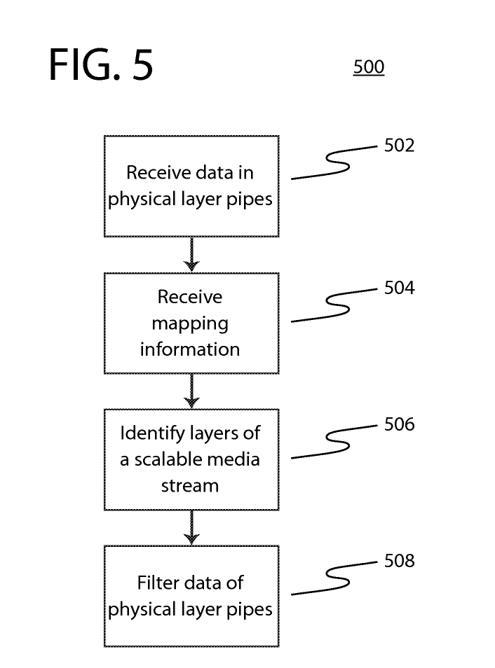

FIG. 5 shows a flowchart of a method 500 for receiving and filtering packets of a scalable media stream comprising signaling information according to an example embodiment of the invention. Method 500 may be performed for example by apparatus 114, 116, 118 of FIG. 1. At block 502 data is received in at least one physical layer pipe (PLP) of a transmission, for example of a broadcast transmission, such as a broadcast transmission of a DVB-T2 system or any other broadcast transmission system. In an example embodiment, one or more layers of a scalable media stream are received in the one or more PLPs, such as layers of a scalable media stream as transmitted in block 306 of FIG. 3. At block 504, mapping information is received describing the mapping of the one or more layers of the scalable media stream to the one or more PLPs. The mapping information may be received in a component identifier as described in relation to table 1. The mapping information may be received in the same transmission or in a different transmission, for example in a bidirectional cellular transmission. At block 506, one or more layers of a scalable media stream are identified based at least in part on the received mapping information. At block 508, data from the PLPs may be filtered based at least in part on the received mapping information. Data from PLPs corresponding to layers of the scalable media stream required at an apparatus may be received, while data from PLPs not needed at the apparatus may be discarded. Higher layer information, such as information received in a session description file, may be used to further aid the identification of layers that may be received and other layers that may be discarded.

In an example embodiment, a receiver receives a scalable media stream, wherein each layer of the scalable media stream is transmitted in a physical layer pipe. From a session description file, the receiver may be aware that the scalable media stream comprises the following layers:

a base layer of an audio stream with a bit rate of 16000 bit/s;

an audio enhancement layer of the audio stream for a cumulative bit rate of 32000 bit/s;

a base layer of a video stream with a bit rate of 128000 bit/s for a resolution of 176×144 pixels at a frame rate of 15 frames/s and a low quality (quality=0);

an enhancement layer of the video stream with a cumulative bit rate of 256000 bit/s for a resolution of 176×144 pixels at a frame rate of 15 frames/s and a high quality (quality=1);

an enhancement layer of the video stream with a cumulative bit rate of 512000 bit/s for a resolution of 352×288 pixels at a frame rate of 30 frames/s and a low quality (quality=0); and a further enhancement layer of the video stream with a cumulative bit rate of 768000 bit/s for a resolution of 352×288 pixels at a frame rate of 30 frames/s and a high quality (quality=1).

The receiver may be an apparatus with a display of 240×160 pixels and a processor capable of decoding video streams at a bit rate of 256000 bit/s with a frame rate of 15 frames/s. The apparatus may also provide audio decoding capability of a bit rate of 16000 bit/s. Therefore, the receiver selects the base layer of the audio stream with 16000 bit/s. The receiver compares the properties of the base and enhancement video layers with its capabilities and concludes that it is capable of decoding the base and first enhancement layers of the video stream, providing a high quality at a resolution of 176×144 pixel and a frame rate of 15 frames/s.

From a received component identifier descriptor it may derive the PLP unique ID values for the PLPs comprising the selected layers. For example, the receiver may find a mapping of the base layer of the audio stream to PLP-ID 0xA1 (hexadecimal value), and a mapping of the base and first enhancement layers to PLP-IDs 0xC1 and 0xC2, respectively. Thus, it will filter the incoming data stream for data from PLPs with a PLP-ID 0xA1, 0xC1 and 0xC2. The receiver may not receive data from PLPs with other unique IDs.

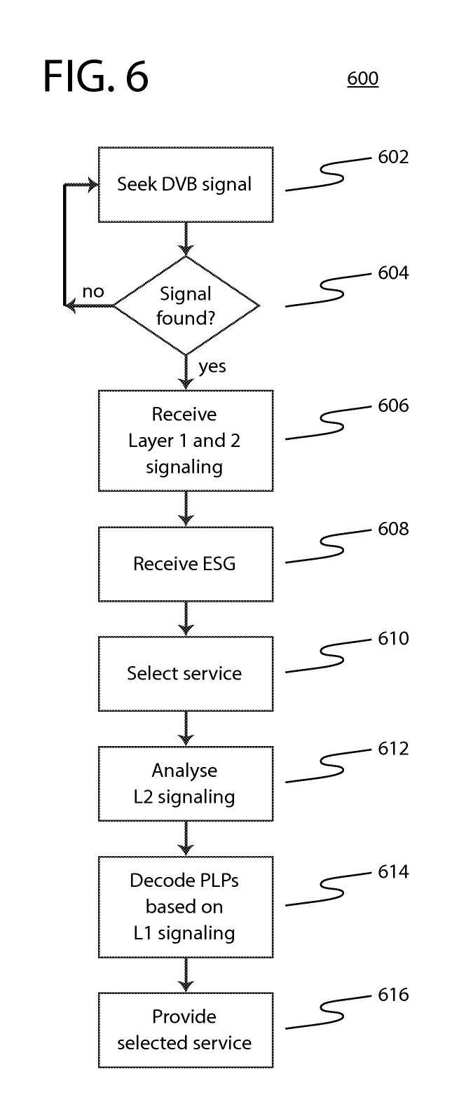

FIG. 6 shows a flowchart of a method 600 for receiving a service, for example a television program or television channel selected by a user, from a broadcasting stream according to an example embodiment of the invention. At block 602, an apparatus seeks a DVB signal, for example apparatus 118 of FIG. 1. If a DVB signal is found at block 604, layer 1 and layer 2 signaling information is received at block 606. Layer 1 signaling may comprise mapping information about the mapping of the PLPs to physical layer frames, for example mapping information of the PLPs to OFDM symbols within DVB data frames and/or DVB data packets. Layer 2 signaling may comprise a mapping of one or more layers of a scalable media stream to the PLPs. At block 608, electronic service guide (ESG) information is received comprising a session description file. Information from the ESG and session description file is analysed, and a service is selected at block 610, for example by a user selection of a television program or television channel. The session description file may provide information on components of the service. The service may correspond to a scalable media stream, and the components of the service may correspond to layers of the scalable media stream.

At block 612, the apparatus analyses the layer 2 signaling information, for example information in a component identifier descriptor, for the selected layers. From the information in the layer 2 signaling, the apparatus identifies PLPs from which to receive data in order to obtain the selected layers. At block 614, the identified PLPs are decoded based on the layer 1 signaling. Received data from the selected PLPs is further processed in order to provide the selected service at block 616, for example by rendering video of a television program on a display of the apparatus and providing audio through a loudspeaker or an audio headset.

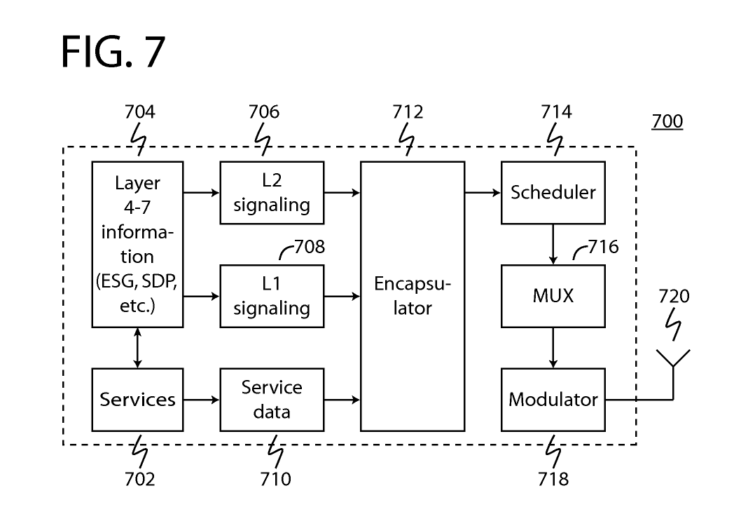

FIG. 7 shows an example embodiment of a head-end 700 including signaling information in a transmission. Head-end 700 may be incorporated in internet provider 104 and/or transmitters 106, 108 of FIG. 1. Head-end 700 may further carry out the method of FIG. 3 and/or the method of FIG. 4. One or more services are provided at block 702. A service may also be received from a service provider, for example service provider 102 of FIG. 1. A service may comprise a scalable media stream. At block 704, higher layer information related to the one or more services is compiled, for example in an ESG file or a session description file. In an example embodiment, components of the service are described in the session description file, such as one or more layers of the scalable media stream. At block 706, layer 2 signaling is added to the higher layer information. Layer 2 signaling may comprise a mapping of one or more layers of a scalable media stream to one or more PLPs. Further, at block 708, layer 1 signaling is added. Layer 1 signaling may comprise information about an association of the PLPs to services and/or service components. At block 710, the one or more services are provided in a data format suitable for processing by the encapsulator 712. Signaling data from blocks 706 and 708 and service data from block 710 are encapsulated into packets and/or sections at encapsulator 712. The packets are scheduled for transmission at block 714 and multiplexed into a data stream at block 716. The data stream is modulated at block 718 for transmission in an assigned frequency band through antenna 720.

Execution of the function of head-end 700 may be done by hardware or by software that is run on a processor. Software comprising data and instructions to run functions of head-end 700 may be stored inside the head-end or may be loaded into head-end from an external source. For example, software may be stored on an external memory like a memory stick comprising one or more FLASH memory components, a compact disc (CD), a digital versatile disc (DVD), or the like. Software or software components for running head-end 700 may also be loaded from a remote server, for example through the internet.

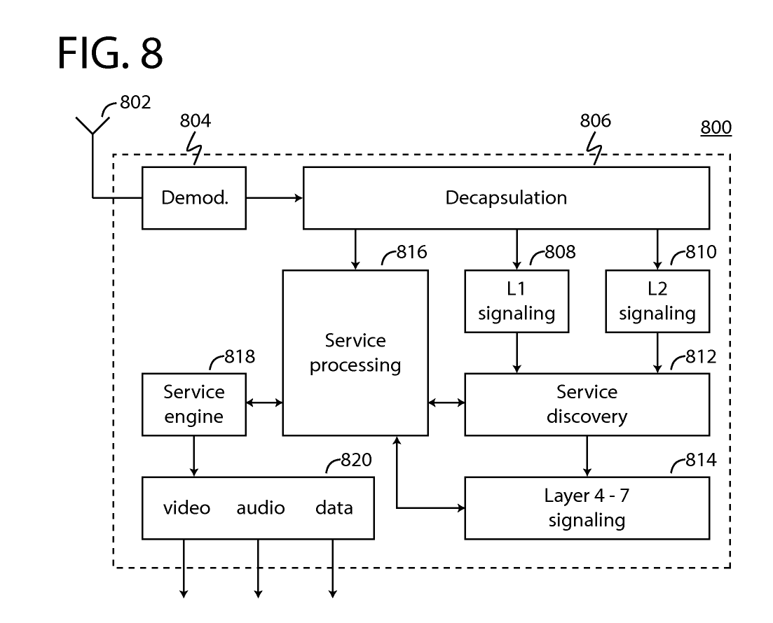

FIG. 8 shows functional blocks of an apparatus 800 configured to receive a scalable media stream and to process signaling information according to an example embodiment, for example apparatus 114, 116, 118 of FIG. 1. Apparatus 800 receives an RF signal comprising a scalable media stream from antenna 802, for example an RF signal of a DVB transmission. In an example embodiment, the received signal may have been transmitted from head-end 700 of FIG. 7. The RF signal is demodulated at demodulator 804. The demodulated signal is decapsulated at block 806. Layer 1 signaling is extracted at block 808, for example signaling comprising mapping information of an association of PLPs to services and/or service components. At block 810, layer 2 signaling is extracted, for example signaling comprising mapping information about the mapping of one or more layers of the scalable media stream to one or more PLPs. Service discovery is performed at block 812 and higher layer signaling is received at block 814, for example an ESG and a session description file describing components of a service such as one or more layers of the scalable media stream.

Block 816 receives signaling data and information about the discovered services from block 812 and the higher layer signaling from block 814 to process the layers extracted from the PLPs of the decapsulated signal received from decapsulator 806. For example, block 816 identifies the one or more layers of the scalable media stream in the PLPs based on the received mapping information in the signaling data. Block 816 may filter the PLPs to receive the layers that may be rendered on a display of the apparatus 800 or coupled to apparatus 800. Block 816 may further filter the PLPs of the decapsulated signal to receive the layers that may be played back on a coupled audio device, such as a loudspeaker or audio headset. Block 816 may further filter the PLPs to receive additional data of the scalable media stream. Filtered data is processed at service engine 818 and a video and/or audio stream is extracted at block 820. Block 820 may further extract the additional data, for example data to be rendered on a display. Additional data may comprise subtitles, information about and related to the scalable media stream such as advertisements, link information, and the like.

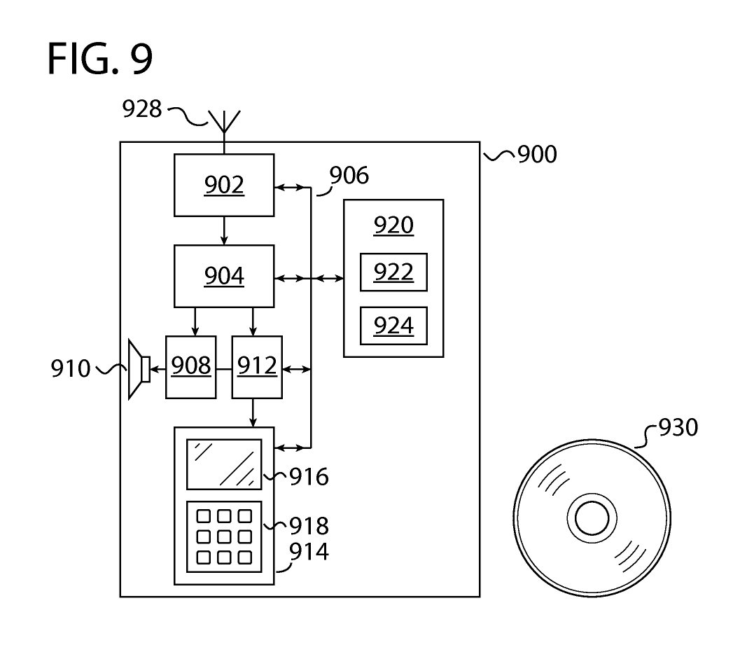

FIG. 9 shows building blocks of an apparatus configured to receive packets of a scalable media stream according to an example embodiment, for example apparatus 800 of FIG. 8. Apparatus 900 may be a mobile apparatus, for example a mobile phone. Apparatus 900 comprises a receiver 902 configured to receive a transmission of a scalable media stream comprising one or more layers. In an example embodiment, the transmission may be received through antenna 928. In another example embodiment, the transmission may be received through a cable connection. Incoming packets of the media stream are forwarded to a controller or processor 904. Processor 904 may be a digital signal processor (DSP), a microcontroller unit (MCU), a reduced instruction set controller (RISC), or any other kind of processor with sufficient processing capabilities. Processor 904 may perform a packet decapsulation and extraction of signaling information. Thus, processor 904 may extract layer 1 signaling information, layer 2 signaling information and/or higher layer signaling information comprising an ESG and a session description file. By extracting signaling information, processor 904 may identify an association of data packets to PLPs (layer 1 signaling). Further, by extracting signaling information, processor 904 may identify an association of PLPs to layers of the received scalable media streams (layer 2 signaling). Processor 904 may also identify additional information about the layers of the received scalable media streams (higher layer signaling). Processor 904 may thus identify one or more layers of the scalable media stream based on the received signaling information. Identification of the layers may be used for filtering layers from the received PLPs for rendering on a user interface (UI). Filtering may also be done by the processor 904.

Apparatus 900 may comprise one or more memory blocks 920. Memory 920 may comprise volatile memory 922, for example random access memory (RAM). Volatile memory 922 may be used to store data received from receiver 902, for example data of a scalable media stream at various processing and filtering stages, configuration data for apparatus 900, and the like. Processor 904 may communicate with memory blocks 920 through a bidirectional bus 906 in order to read and store data and/or instructions.

Filtered audio layers are output from processor 904 to audio decoder 908. Audio decoder 908 decodes the audio data in the filtered audio layers and converts the data to an analog audio signal. Analog audio signal may be played back on loudspeaker 910. In an example embodiment, the analog audio signal is played back on a coupled audio headset.

Filtered video layers are forwarded from processor 904 to video decoder 912 which prepares the video data of the video layers for play back on user interface 914. User interface comprises a display 916. User interface 914 may further comprise a keyboard 918 for entering user data. User data may comprise a user preference, for example a user preference for viewing a scalable media stream at a certain video and/or audio quality, resolution, frame rate, and the like. A user preference may be used by processor 904 to determine which audio and video layers of the scalable media stream to filter and which layers to discard.

Filtering may be done based on one or more capabilities of apparatus 900. In an example embodiment, audio decoder 908 may be capable of decoding a low quality audio stream with a bit rate of 16000 bit/s. Further, display 916 of apparatus 900 may provide a resolution of 300×200 pixels and be capable of rendering a video stream with a frame rate of 15 frames/s. Video decoder 912 may be capable of decoding an incoming video bit stream of a bit rate of 128000 bit/s.

From the session description file received in the higher layer information, processor 904 extracts the information that the scalable media stream contains the following audio layers:

audio base layer with a bit rate of 16000 bit/s, and
audio enhancement layer with a cumulative bit rate of 32000 bit/s.

From the session description file the processor 904 further extracts the following information on video layers:

base video layer with a bit rate of 128000 bit/s, resolution 176×144, framerate 15, quality 0;
enhancement layer 1, bit rate 256000 bit/s, resolution 176×144, framerate 15, quality 1;
enhancement layer 2, bit rate 512000 bit/s, resolution 352×288, framerate 30, quality 0;
enhancement layer 3, bit rate 768000 bit/s, resolution 352×288, framerate 30, quality 1.

Therefore, processor 904 may decide to filter the base audio layer of the received data stream and the base video layer in order to match the capabilities of the receiver.

In another example embodiment, audio decoder 908 may be capable of decoding a high quality audio stream of a bit rate of 32000 bit/s. Video decoder 912 may be capable of decoding an incoming bit stream of a bit rate of 768000 bit/s (high quality) at a frame rate of 30 frames/s. Display 916 may further have a resolution of 600×400 pixel. The same scalable media stream is received. Thus, processor 904 filters the base and enhancement audio layers and forwards them to audio decoder 908. Processor 904 also filters the base video layer and enhancement video layers 1 to 3 and forwards them to video decoder 912.

In a further example embodiment, apparatus 900 may have the same capabilities as just described. Energy for apparatus 900 may be provided by a battery. Apparatus 900 may detect a user preference or receive a user input, for example on keyboard 918 of user interface 914, to use only the low quality (quality=0) video stream in order to reduce power consumption and increase battery life. Therefore, processor 904 filters the base and enhancement audio layers and forwards them to audio decoder 908. Processor 904 also filters the base video layer and enhancement video layers 1 to 2 and forwards them to video decoder 912. However, video enhancement layer 3 is discarded by processor 904.

Memory 920 may also comprise non volatile memory 924, for example read only memory (ROM), FLASH memory, or the like. Non-volatile memory 924 may be used to store software instructions for processor 904. All or one or more parts of memory 920 may also be embedded with processor 904. Software comprising data and instructions to run apparatus 900 may also be loaded into memory 920 from an external source. For example, software may be stored on an external memory like a memory stick comprising one or more FLASH memory components, a compact disc (CD), a digital versatile disc (DVD) 930, or the like. Software or software components for running apparatus 900 may also be loaded from a remote server, for example through the internet.

Processor 904 may further communicate with receiver 902, audio decoder 908, video decoder 912 and UI 914 through bidirectional bus 906. Processor 904 may configure and control operation of these blocks. Processor 904 may also receive status information from these blocks through bidirectional bus 906.

Without in any way limiting the scope, interpretation, or application of the claims appearing below, a technical effect of one or more of the example embodiments disclosed herein may be that a mapping of layers of a scalable media stream to one or more PLPs is identified. Another technical effect of one or more of the example embodiments disclosed herein may be that an end-to-end solution for the signaling in a DVB stream, such as DVB-NGH or DVB-T2, is provided. The scalable video codec (SVC) service is labeled within the ESG, and the service components are distinguished within the layer 2 as base layer and enhancement layer streams and/or service components together with other service components such as data and audio. Another technical effect of one or more of the example embodiments disclosed herein may be that battery efficiency of a battery supplied receiver is increased, as PLPs are identified by the signaling and only the identified PLPs may be received and/or processed.

Embodiments of the present invention may be implemented in software, hardware, application logic, an application specific integrated circuit (ASIC) or a combination of software, hardware and application logic. The software, application logic and/or hardware may reside on an apparatus or an accessory to the apparatus. For example, the receiver may reside on a mobile TV accessory connected to a mobile phone. If desired, part of the software, application logic and/or hardware may reside on an apparatus, part of the software, application logic and/or hardware may reside on an accessory. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
mapping one or more layers of a scalable media stream to at least one physical layer pipe of a transmission;
transmitting information related to the mapping; and
transmitting the one or more layers in the at least one physical layer pipe.

2. The method of claim 1, wherein the information related to the mapping is transmitted in a component identifier descriptor.

3. The method of claim 1, wherein the one or more layers of the scalable media stream correspond to components of a service, further comprising:
describing the components of the service in a session description file; and
transmitting the session description file.

4. The method of claim 1, further comprising:
signaling an association of the at least one physical layer pipe with a physical layer frame of the transmission.

5. The method of claim 1, wherein the scalable media stream comprises one or more layers of a video stream.

6. The method of claim 1, wherein the scalable media stream comprises one or more layers of an audio stream.

7. A method, comprising:
receiving data in at least one physical layer pipe;
receiving information related to a mapping of one or more layers of a scalable media stream to the at least one physical layer pipe; and
identifying the one or more layers of the scalable media stream in the received data based on the received information related to the mapping.

8. The method of claim 7, wherein the information related to the mapping is received in a component identifier descriptor.

9. The method of claim 7, wherein the scalable media stream corresponds to a service and the one or more layers of the scalable media stream correspond to components of the service, further comprising:
receiving a session description file describing the components of the service; and
filtering the received data for components of the service.

10. The method of claim 7, further comprising:
receiving a signaling of an association of the at least one physical layer pipe with a physical layer frame.

11. The method of claim 7, wherein the scalable media stream comprises one or more layers of a video stream.

12. The method of claim 7, wherein the scalable media stream comprises one or more layers of an audio stream.

13. An apparatus comprising:
a controller configured to map one or more layers of a scalable media stream to at least one physical layer pipe of a transmission;
a transmitter configured to transmit information related to the mapping;
wherein the transmitter is further configured to transmit the one or more layers in the at least one physical layer pipe.

14. The apparatus of claim 13, wherein information related to the mapping is transmitted in a component identifier descriptor.

15. The apparatus of claim 13, wherein the one or more layers of the scalable media stream correspond to components of a service,
wherein the controller is further configured to describe the components of the service in a session description file; and
wherein the transmitter is further configured to transmit the session description file.

16. The apparatus of claim 13, wherein the transmitter is further configured to transmit signaling information comprising an association of the at least one physical layer pipe with a physical layer frame of the transmission.

17. The apparatus of claim 13, wherein the scalable media stream comprises one or more layers of a video stream.

18. The apparatus of claim 13, wherein the scalable media stream comprises one or more layers of an audio stream.

19. An apparatus, comprising:
a receiver configured to receive data in at least one physical layer pipe; wherein the receiver is further configured to receive information related to a mapping of one or more layers of a scalable media stream to the at least one physical layer pipe; and
a controller configured to identify the one or more layers of the scalable media stream in the received data based on the received information related to the mapping.

20. The apparatus of claim 19, wherein the mapping is described in a component identifier descriptor.

21. The apparatus of claim 19, wherein the scalable media stream corresponds to a service and the one or more layers of the scalable media stream correspond to components of the service;
wherein the receiver is further configured to receive in a session description file describing the components of the service; and
wherein the controller is further configured to filter the received data for components of the service.

22. The apparatus of claim 19, wherein the receiver is further configured to receive a signaling of an association of the at least one physical layer pipe with a physical layer frame of the transmission.

23. The apparatus of claim 19, wherein the scalable media stream comprises one or more layers of a video stream.

24. The apparatus of claim 19, wherein the scalable media stream comprises one or more layers of an audio stream.

25. A computer program product comprising a computer-readable medium bearing computer program code embodied therein for use with a computer, the computer program code comprising:
code for mapping one or more layers of a scalable media stream to at least one physical layer pipe of a transmission;
code for transmitting information related to the mapping; and
code for transmitting the one or more layers in the at least one physical layer pipe.

26. A computer readable medium containing a data structure for a component identifier descriptor, the data structure comprising a mapping of one or more layers of a scalable media stream to at least one physical layer pipe of a transmission.
